(19) United States
(12) Patent Application Publication
(10) Pub. No.: US 2003/0033744 A1
(43) Pub. Date: Feb. 20, 2003

(54) Method and apparatus for organizing hang-up garments for challenged persons

(76) Inventor: Beryl Ann Alexander, Hearst, TX (US)

Correspondence Address: Rudolph J. Buchel, Jr., 7113 Dobins Drive, Plano, TX, 75025, US

(21) Appl. No.: 09/932,550

(22) Filed: Aug. 17, 2001

(51) Int. Cl. G09F 3/18

(52) U.S. Cl. 40/660

(57) ABSTRACT

The present invention optimizes searching for a garment by localizing an area to be searched to a portion of the original search area through the use of closet organizers. The present invention is particularly useful for challenged persons by decreasing the area for searching for a garment to a more manageable portion thereof. Accordingly, with respect to one exemplary embodiment of the present invention a plurality of closest organizers subdivide a closet into a plurality of sections and each section contains a group or collection of garments each having a matching attribute. Coinciding with and proximate to each group of garments is a closest organizer having a unique characteristic or attribute that corresponds to a matching attribute that is common to each of the garments in the of the collection of garments located in a particular section. Identification attributes on the closet organizers are selected based on the user's ability to comprehend the selected closet organizer attribute.

### BACKGROUND OF THE INVENTION

1. Field of the Invention

The present invention relates generally to the field of wearing apparel, and more particularly to a method and apparatus for organizing wearing apparel such that optimizing search time.

2. Description of Related Art

In the fashion and garment industry it is known to organize garments such that they can be readily found in a group of garments. In the retail environment, it is the normal practice for clothiers to segregate garments by the garment attribute. Initially garments are segregated by gender and dispersed to men's and women's departments in a retail establishment. Men's and women's garments may be further divided up by age groups which are often relegated to individual areas or sections of their respective departments. For example very often the woman's department in a retail establishment will maintain a children, junior, teen, young adult and women section for displaying women's garments having various attributes corresponding to the type of female likely to buy such a garment. Conveniently then, customers can then go to a department and into an area in the department to shop for different types of garment, but all having common attributes of gender and age group.

Generally, garments located in a particular section of a department are further broken down and organized by garment type and/or style and arranged in display cases or on traditional hang-rails, face-out fixtures or other types of hang-up racks by garment size. In a men's department, trousers may be located in their own sub-area on hang-up racks, while dress shirts may be shown in display racks for the customers and they too organized by garment size. In a women's department, blouses are often hung on hang-up racks located in their own sub-area on hang-up racks, followed by hang-up racks for dresses in a particular space, and other garments such as fashion apparel, suits, pants, undergarment and so on, each being organized by garment size for the customer's convenience.

Customers rely on courtesy signs in the retail establishment for finding a department and area and then generally merely look around the area for a garment type that they are interested in shopping for. Once a hang-up rack or group of racks has been located for the desired type of garment, the customer peruses garments on the rack and for a particular style or fashion. Often a hang-up rack will contain several tens and possibly hundreds of articles of clothes from which to choose. Merely hanging an assortment of garment types in a haphazard manner lessens the effectiveness of a customer in finding garments to purchase and thereby reduces the quantity of different garment that might be found and purchase.

Clothiers experience a corresponding increase in sales, and therefore profits, to the ease with which a customer can identify a suitable garment. Therefore, it is the custom in the retail garment industry to display a particular style of a garment type on a hang-up rack that is separated from other hang-up racks with different style of the identical garment type. For example, denim pants may be relegated to one or more hang-up rack while dress trousers will hang from a completely separate hang-up rack. However, with respect to the commercial aspect the retail garment industry, fit, i.e. the customer's size, is often a more important organizational factor to a customer that styling. Once a customer decides on a particular style of garment, the customer proceeds to find a specific sized garment. If the customer is unable to quickly ascertain that a particular size of the desired garment is available for purchase, the customer may spend an unwarranted amount of time searching a hang-up rack for the needed size. If the search end without the customer having found the garment, then the customer is likely leave the establishment frustrated and possibly never return. Therefore, clothiers employ excessive measures to organize garments so that a customer can easily find a size, or alternatively for a customer can quickly and definitively determine that the size is not available. When a customer quickly ascertains that a sought after size is available, the customer has more time to try on the garment for fit, and if necessary, find a garment with a more suitable. Moreover, if the customer can quickly determine that a particular size is not available, the disappointment felt by the customer is only temporary as customers usually appreciate that a clothier cannot permanently maintain stocks of all sizes of every garment type—such is simply contrary to fashion.

Sizing garments, or organizing garments by size, is a major part of retailing. Clerks and store owns spend incalculable amounts of time hanging and re-hanging garments on hang-up racks by size, thereby making the garment more accessible to the customer. However, organization alone is not enough to ensure customer find a garment size, the particular size must be readily visible to a customer. Then, once a customer realizes an interest in a particular size and style of garment, the customer's attention is directed to the needed size. Size organizational schemes vary but generally consist of size indicia displayed proximate to a correspondingly sized group of garments. One common method of organizing garment on a hang-up rack by size is by placing size indicator between like sized garments which identify the size value. Often these size indicators are round with a slotted hole for receiving the hang-up rod, referred to as a “rounder.” Imprinted on the opposing faces of the rounder is size indicia which, when secured in place on the rod of a hang-up rack, can easily be seen by customers. Rounders have the advantage of remaining secured and slidable with the hang-up rod regardless of its orientation in the rod. Aside for the round shaped rounders, some other generic shape may be substituted by fashioning a rod hook at the upper end for securing to the hang-up rod, however these devices have the disadvantage of being less visible to customers than conventional rounders because the geometric shape with the size indicia is often partially obscured by hangers. With regard to other schemes, size markers may be affixed directly to the hanger body itself. While these markers are usually visible over other hanger, they have the disadvantage of being smaller that rounders, thus smaller and harder to read size indicia, and are much more labor intensive as the size of each garment must correspond to its hanger size marker. As a group, typically such devices are know generically as “sizers.”

As is known, various types of markers have been provided for garment hangers in order to indicate the size of a garment suspended from the hanger. For example, U.S. Pat. No. 4,115,940 describes a size indicator which is mounted on a mounting member extending between a hanger body and a hook of the hanger. The marker is itself of a generally U-shaped cross-section so as to fit over the mounting member of the hanger. In addition, internal ribs have been provided on the marker to engage under an enlarged head or bead on the mounting member so as to retain the marker in place. U.S. Pat. Nos. 5,096,101, 5,199,608, 5,305,933 and 5,383,583 describe markers which can be mounted on hangers at the nexus between a hanger body and a hook so as to be permanently secured in place. Such markers are intended to be child-resistant. That is, the markers are permanently mounted on the hangers and cannot be readily removed without destroying the markers. U.S. Pat. Nos. 5,687,887, 5,950,883, 6,019,260 and 6,041,984 describe a side sizer system including a marker which can be mounted on a hanger in a self-locking manner, wherein the marker is fitted over an integral rib located at a juncture between a hook and the hanger body so as to engage under the rib in a self-locking relationship. U.S. Pat. No. 5,944,237 describes method and system for color coding the sizes of garments to be displayed and sold in a retail clothing or department store which has a plurality of clothing lines for a plurality of consumer groups, wherein each consumer group includes individual consumers of similar physiology. The system and method provide a uniform color sizing code to assist individual consumers in locating items of clothing in different lines of clothing appropriate to their personal physiology.

As can be appreciated for the description above, any person attempting to find a particular type, style and size of garment must be sighted and have possess reasonable cognitive faculties such that the garment attribute indicia can be understood. However, challenged persons also need a mechanism for navigating garments on a hang-up rack.

### BRIEF SUMMARY OF THE INVENTION

The present invention optimizes searching for a garment by localizing an area to be searched to a portion of the original search area through the use of closet organizers. The present invention is particularly useful for challenged persons by decreasing the area for searching for a garment to a more manageable portion thereof. Accordingly, with respect to one exemplary embodiment of the present invention a plurality of closest organizers subdivide a closet into a plurality of sections and each section contains a group or collection of garments each having a matching attribute. Coinciding with and proximate to each group of garments is a closest organizer having a unique characteristic or attribute that corresponds to a matching attribute that is common to each of the garments in the of the collection of garments located in a particular section. Identification attributes on the closet organizers are selected based on the user's ability to comprehend the selected closet organizer attribute.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 is a diagram of a closet organizer for identifying a portion of a closet reserved for dresses in accordance with an exemplary embodiment of the present invention;

FIG. 2 is a diagram of a closet organizer for identifying a portion of a closet reserved for pants in accordance with an exemplary embodiment of the present invention;

FIG. 3 is a diagram of a closet organizer for identifying a portion of a closet reserved for skirts in accordance with an exemplary embodiment of the present invention;

FIG. 4 is a diagram of a closet organizer for identifying a portion of a closet reserved for shirts in accordance with an exemplary embodiment of the present invention;

FIG. 5 is a diagram of an easily comprehendible closet organizer for identifying a portion of a closet reserved for dresses in accordance with an exemplary embodiment of the present invention;

FIG. 6 is a diagram of an easily comprehendible closet organizer for identifying a portion of a closet reserved for pants in accordance with an exemplary embodiment of the present invention;

FIG. 7 is a diagram of an easily comprehendible closet organizer for identifying a portion of a closet reserved for skirts in accordance with an exemplary embodiment of the present invention;

FIG. 8 is a diagram of an easily comprehendible closet organizer for identifying a portion of a closet reserved for shirts in accordance with an exemplary embodiment of the present invention;

FIG. 9 is a diagram of a garment organizer for identifying a portion of a closet reserved for dresses in accordance with an exemplary embodiment of the present invention;

FIG. 10 is a diagram of a garment organizer for identifying a portion of a closet reserved for pants in accordance with an exemplary embodiment of the present invention;

FIG. 11 is a diagram of a garment organizer for identifying a portion of a closet reserved for skirts in accordance with an exemplary embodiment of the present invention; and

FIG. 12 is a diagram of a garment organizer for identifying a portion of a closet reserved for shirts in accordance with an exemplary embodiment of the present invention.

Other features of the present invention will be apparent from the accompanying drawings and from the detailed description which follows.

### DETAILED DESCRIPTION OF THE INVENTION

Persons suffering from a physical, mental or sensory infirmities are faced with and must overcome challenges that non-challenged persons rarely realize. The challenged face identical time constraints as non-challenged but often ordinary tasks involve excessive expenditures of time to complete. The simple task of finding a garment often becomes an extended search for persons who cannot readily perceive a garment from a distance. Therefore, in accordance with an exemplary embodiment of the present invention an apparatus and method for organizing hang-up garments by garment attributes is described wherein hanger organizer comprises garment attribute indicia corresponding to hang up garment(s) such that a challenged person need not perceive the actual garment when locating same. For the purposes herein, a challenged person or the challenged refers to any person that does no possess the physical, mental or sensory faculties to readily distinguish garments or garment types, colors or other garment attributes of hanging garments. The challenged may refer to persons who do not possess full physical, mental or sensory faculties due to age.

The present invention recognizes that time devoted to searching for a garment can be optimized by localizing an area to be searched to a portion of the original search area. In so doing, the present invention allows for time saving time that is proportional to the reduction in the size of the area to be searched. The present invention is particularly useful for challenged persons by decreasing the area for searching for a garment to a more manageable portion thereof. For instance, a closet might be subdivided into sections for locating a particular garment in the closet, wherein the size of each section is a portion of the original closet size. Accordingly, with respect to one exemplary embodiment of the present invention a plurality of closest organizers subdivide a closet into a plurality of sections and each section contains a group or collection of garments each having a matching attribute. Coinciding with and proximate to each group of garments is a closest organizer having a unique characteristic or attribute that corresponds to a matching attribute that is common to each of the garments in the of the collection of garments located in a particular section. Thus, finding a section of a storage area having garments each with a common attribute is a simple matter of locating a closet organizer having the corresponding unique characteristic or attribute. With respect to one example, a garment storage area might be a closet organized by garment color. In that example garment color would be the garment attribute and groups of garments having a common color or color scheme color would be coalesced into a particular sections of the closet. Sections would then be set apart from one another using closest organizers in accordance with the present invention. Each closet organizer for a section identifies unique garment color attributes by corresponding closet organizer characteristics or attributes that are unique to the particular section of garments being identified. With respect to one example, groups of red garments are organized together with a closet organizer having a red color scheme. Here, the closet organizer utilizes a red color as an indicator or identifier of the garment attribute common to all garments in the section set apart b the closet organizer.

While the embodiment illustrated above may provide some minimal time saving to sighted persons who are unfamiliar with their garment organization, the improvement described above provides little benefit to those persons than cannot recognize color, such as color blind or visually challenged persons. Therefore, in accordance with another accept of the present invention, closet organizer characteristics and attributes are selected based on the ability of the user to comprehend the selected characteristics and/or attributes. It is simply not logical to select an identification attribute that is equally as incomprehensible for a user as the garment attribute it purports to identify. Therefore, in some situations a better choice of organizer attribute representing a garment color attribute might be a textual message or simply a color description embossed on each of the closet organizers. In this case a textual message or color description can easily be comprehended by, for example, a person suffering from color blindness. Thus, in accordance with another embodiment of the present invention, a closet organizer of the present invention signifies a garment's color attribute using some other characteristic or attribute such a visual text or Braille indicia, two- or three-dimensional shape attribute, symbolic shape. However, if the intended user cannot comprehend visual text, such as the case of visually challenged persons, then the visual attribute would provide no queues to the user of the garments' color attribute. With respect to this final case, still a better organizer attribute for representing garment color might be using the Braille system of raised dots that represent alphabetic text, or some other tactile attribute that can be distinguished by feel.

While the prior art discloses a plurality of rack organizers, rounders or the like, subdividing a rack into sections of garments of matching sizes, with respect to the present invention the term “garment attribute” or simply “attribute” is specifically intended to exclude size as a garment characteristic or attribute because size is an attribute of the user. This is so because it is envisioned that the present invention will be primarily practiced by individual persons rather than in a retail establishment. Clearly garment size cannot be used as a basis for segregating garments for individuals because in most cases all garments own by an individual have a common size attribute. Thus the search area could not be effectively reduced by organizing an individual's garments by size.

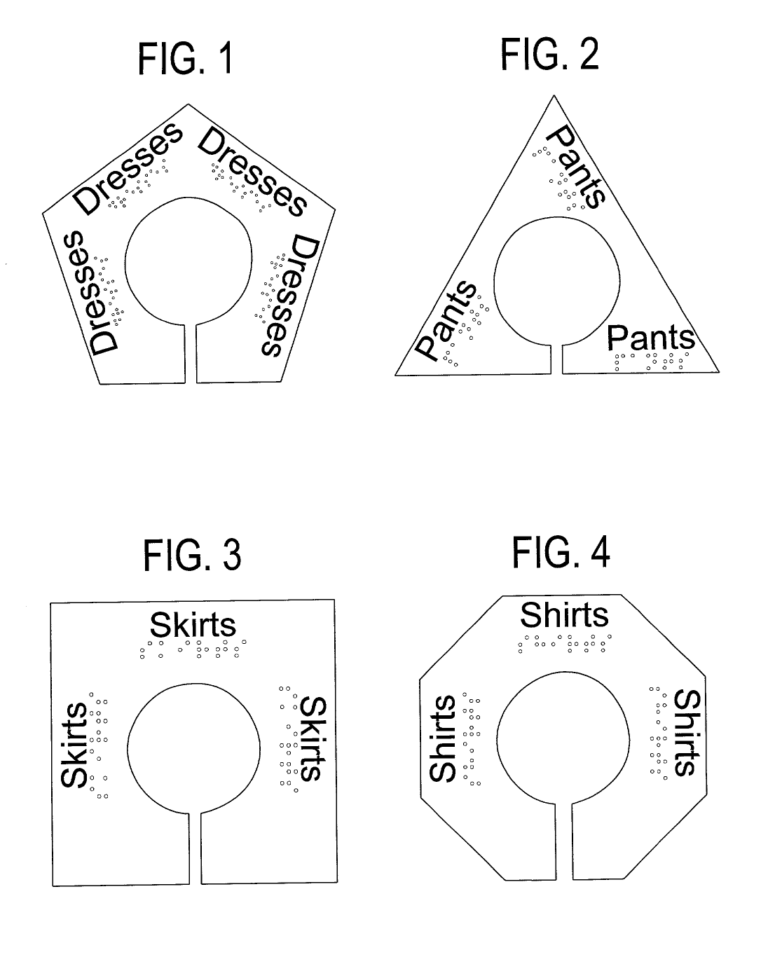

FIGS. 1-4 are diagrams of the “Closet Wizz” closet organizers for organizing hang-up garments by identifying portions of a closet having garments with a common garment attribute in accordance with an exemplary embodiment of the present invention. With respect to one aspect of the present invention, at least one closet organizer characteristic or attribute correlates to one attribute that is common to all garments in a portion of the search area, i.e. usually the search area is a closet or other location where garments are hung for display. Note that each of closet organizers 100-400 are similar in that each has hole 102-402 for receiving a closet or hang up rod and slit 104-404 for placement on the closet rod. In general it is expected that the closet organizers are composed of a resilient and flexible substrate, such a polymer plastic. However, each of closet organizers 100-400 differ from one another by three characteristics or attributes: two-dimensional shape; text indicia; and Braille indicia. Here, unique two-dimensional geometric primitives are used to identify a plurality of garments of a common type. Likewise, messaging indicia is used, visual and Braille text. In accordance with one exemplary embodiment of the present invention, each of the three characteristics or attributes may correlate to a single garment attribute or may instead correlate to three different garment attributes. In the depicted figures, each of the three characteristics or attributes correlate to garment type. Thus, a challenged person can expeditiously locate the portion of a closet containing a particular type of garment, because the search area is reduced from the entire closet to only one portion of the closet. In the presently depicted figures, garment type attributes are represented as “dresses,” “pants,” “skirts” and “shirts,” however this embodiment is merely exemplary. One of ordinary skill in the art would readily realize the other garment type attributes might be represented by the present closet organizers such as suits, coats, tee shirts, blouses, etc. Moreover, the depicted figures represent garment type attributes using three particular characteristics or attributes that correlate to a garment attribute. One of ordinary skill in the art would also readily realize the other closet organizer attributes might be used in place of or in conjunction with the three illustrated in the figures, for example raised text, other two-dimensional shape attributes, three-dimensional shape attribute, symbolic shapes, etc.

Regardless of the type of closet organizer characteristic or attribute selected to correspond with a particular garment attribute, the selected characteristic or attribute must be comprehensible by persons using the present system. For example, it makes little sense to select visual closet organizer attribute for visually challenged persons, similarly selecting message text for young or mentally challenged persons is of no advantage when the user cannot comprehend the message indicia embossed on the closet organizer.

More specifically, FIG. 1 is a diagram of a closet organizers for identifying a portion of a closet reserved for dresses in accordance with an exemplary embodiment of the present invention. Embossed, stamped, engraved or permanently printed on closet organizer 100 embossed is visual indicia 106 for designating a portion of the closet area proximate to the organizer for dresses by displaying the word “DRESSES.” Notice that visual indicia 106 is oriented such that the text is visual regardless of the orientation of closet organizer 100 on a closet rod. Additionally, visual indicia 106 may have raised characters for three-dimensional effect or some other textured surface for a tactile sensation. Also depicted on closet organizer 100 is tactile indicia 108 in the form of raised Braille characters representing the word “dresses.” Tactile indicia 108 is depicted on closet organizer 100 as being proximate to visual indicia 106 but is not necessary for practicing the present invention. With respect to common practice, Braille characters may be raised directly over visual text. Braille characters are an accepted alphabet for the visually challenged but it should be recognized that other symbolic tactile indicia is specifically envisioned. For example, two- or three-dimensional features may be incorporated on closet organizer 100 that are representative or in correlate to garment attributes such as geometric shapes, patterns, lines, or even raised symbology other than Braille. Further with regard to symbology, notice that closet organizer 100 is formed generally in the shape of a pentagon. This shape attribute of closet organizer 100 also correlates to the garment attribute of a dress-type garment, thus providing still another visual and tactile queue for identifying a portion of a closet reserved for dresses. In accordance with another embodiment, closet organizer 100 is fitted with a radial lip (not shown) which is substantially perpendicular to the body of closet organizer 100 and on which both visual and tactile indicia are displayed. One of ordinary skill in the art would also readily realize that other closet organizer attributes might be used in place of or in conjunction with the those illustrated in FIG. 1, for example raised text, other two-dimensional shape attributes, three-dimensional shape attribute, symbolic shapes, surface texture, etc.

FIG. 2 is a diagram of a closet organizers for identifying a portion of a closet reserved for pants in accordance with an exemplary embodiment of the present invention. With respect to closet organizer 200, visual indicia 206 for is presented for designating a portion of the closet area proximate to the organizer for pairs of pants by displaying the word “PANTS.” Tactile indicia 208 in the form of raised Braille characters representing the word “pants” is also shown for signifying an area of the closet for pants. Finally, closet organizer 200 forms a two-dimensional triangle which also corresponds to the garment type attribute of pants.

FIG. 3 is a diagram of a closet organizers for identifying a portion of a closet reserved for skirts in accordance with an exemplary embodiment of the present invention. Here closet organizer 300 is presented with visual indicia 306 for designating a portion of the closet area proximate to the organizer for skirts by displaying the word “SKIRTS.” Tactile indicia 308 also shows raised Braille characters representing the word “skirts.” Finally, closet organizer 300 is in the shape of a square which further signifies the garment type attribute of skirts.

FIG. 4 is a diagram of a closet organizers for identifying a portion of a closet reserved for shirts in accordance with an exemplary embodiment of the present invention. Closet organizer 400 is similar to those described immediately above having visual indicia 406 for designating a portion of the closet area proximate to the organizer for shirts by displaying the word “SHIRTS,” tactile indicia 408 or raised Braille characters representing the word “shirts,” and finally with an unique geometric shape designated to correlate to shirts, an octagon.

One of ordinary skill in the art would readily realize that other garment type attributes might be represented by the present closet organizers such as suits, coats, tee shirts, blouses, etc. The present closet organizers may possess more or fewer characteristics or attributes that correlated to garment attributes. Further, while the exemplary closet organizers are depicted for readily accepting a standard diameter closet rod, the embodiment is merely exemplary. Closet rods and configuration vary and one of ordinary skill in the art would understand that certain modification might be made to the closet organizers to accommodate particular closet features.

The present invention as depicted in FIGS. 1-4 is extremely useful in situations where a caregiver provides for some maintenance of a challenged person, for instance in cases where a relative launders a challenged persons garments. The placement of both recognizable visual indicia and some other indicia or attribute comprehendible to a challenged person allows both parties to easily determine the proper location of a garment with a particular attribute. For example, a father might launder clothes for a challenged child, then by using the present invention easily identifies the portion of the closet reserved for particular garments. Similarly, the time spent hunting for an particular garment by the challenged child is significantly reduced because the child readily comprehends characters or attributes on the closets organizers that correlate to the garment attributes for a garment being sought. If the child want pants, then the child locates a closet organizer for pants and then searches the proximate portion of the closet for the particular pair of pants desired.

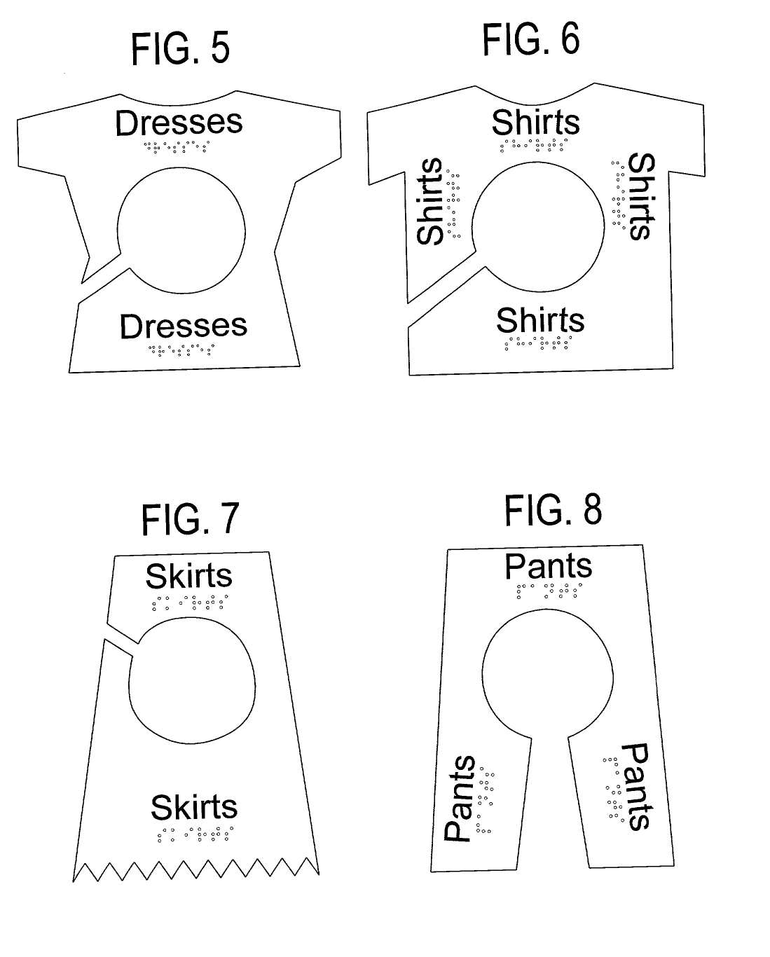

FIGS. 5-8 are diagrams of closet organizers for organizing hang-up garments by identifying portions of a closet having garments with a common garment attribute in accordance with another exemplary embodiment of the present invention. Here again each of closet organizers 500-800 are similar in that each has hole 502-802 for receiving a closet or hang up rod and slit 504-804 for placement on the closet rod as discussed immediately above. However, notice also that each of closet organizers 500-800 differ from one another by three characteristics or attributes: two-dimensional shape; text indicia; and Braille indicia. Here, representative two-dimensional geometric shapes are used that suggest a type of garment. Thus, a user that cannot comprehend either visual or Braille, or that cannot remember or associate arbitrary two-dimensional shapes to garment types is reminded of the garment type by its representative shape. Here to messaging indicia is used, visual and Braille text for persons who can comprehend messaging indicia. In accordance with one exemplary embodiment of the present invention, each of the three characteristics or attributes may correlate to a single garment attribute or may instead correlate to three different garment attributes. In the depicted figures, each of the three characteristics or attributes correlate to garment type. Thus, a challenged person can expeditiously locate the portion of a closet containing a particular type of garment, because the search area is reduced from the entire closet to only one portion of the closet. In the presently depicted figures, garment type attributes are represented as “dresses,” “pants,” “skirts” and “shirts,” however this embodiment is merely exemplary. One of ordinary skill in the art would readily realize the other garment type attributes might be represented by the present closet organizers such as suits, coats, tee shirts, blouses, etc. Moreover, the depicted figures represent garment type attributes using three particular characteristics or attributes that correlate to a garment attribute. One of ordinary skill in the art would also readily realize the other closet organizer attributes might be used in place of or in conjunction with the three illustrated in the figures, for example raised text, other two-dimensional shape attributes, three-dimensional shape attribute, symbolic shapes, surface texture, etc.

More specifically, FIG. 5 is a diagram of a closet organizers for identifying a portion of a closet reserved for dresses in accordance with an exemplary embodiment of the present invention. Closet organizer 500 is similar to closet organizer 100 depicted in FIG. 1 above and having visual indicia 506 displaying the word “DRESSES,” tactile indicia 108 representing the word “dresses,” and a unique shape which correlates to a dress. However, rather than being an arbitrary geometric shape as illustrated by closet organizer 100 depicted in FIG. 1, closet organizer 500 is in the shape of a dress, thus suggesting a dress to one of limited comprehension.

FIG. 6 is a diagram of a closet organizers for identifying a portion of a closet reserved for pants in accordance with an exemplary embodiment of the present invention. Closet organizer 600 displays visual indicia 606 for designating a portion of the closet area proximate to the organizer for pairs of pants by displaying the word “PANTS.” Closet organizer 600 is also shown with tactile indicia 608 in the form of raised Braille characters. Similar to closet organizer 500 described above, closet organizer 600 is in the shape of a pair of pants.

FIG. 7 is a diagram of a closet organizers for identifying a portion of a closet reserved for skirts in accordance with an exemplary embodiment of the present invention. Closet organizer 700 displays visual indicia 706 for designating a portion of the closet area proximate to the organizer for pairs of pants by displaying the word “SKIRTS.” Closet organizer 700 is also shown with tactile indicia 708 in the form of raised Braille characters. Notice here too that closet organizer 700 is in the shape of a pair of a skirt for ease of comprehension.

FIG. 8 is a diagram of a closet organizers for identifying a portion of a closet reserved for shirts in accordance with an exemplary embodiment of the present invention. Closet organizer 400 is similar to those described immediately above having visual indicia 406 for designating a portion of the closet area proximate to the organizer for shirts by displaying the word “SHIRTS,” tactile indicia 408 or raised Braille characters representing the word “shirts,” and finally with an unique geometric shape designated to correlate to shirts, an octagon.

One of ordinary skill in the art would readily realize that other garment type attributes might be represented by the present closet organizers such as suits, coats, tee shirts, blouses, etc. The present closet organizers may possess more or fewer characteristics or attributes that correlated to garment attributes. Further, while the exemplary closet organizers are depicted for readily accepting a standard diameter closet rod, the embodiment is merely exemplary. Closet rods and configuration vary and one of ordinary skill in the art would understand that certain modification might be made to the closet organizers to accommodate particular closet features.

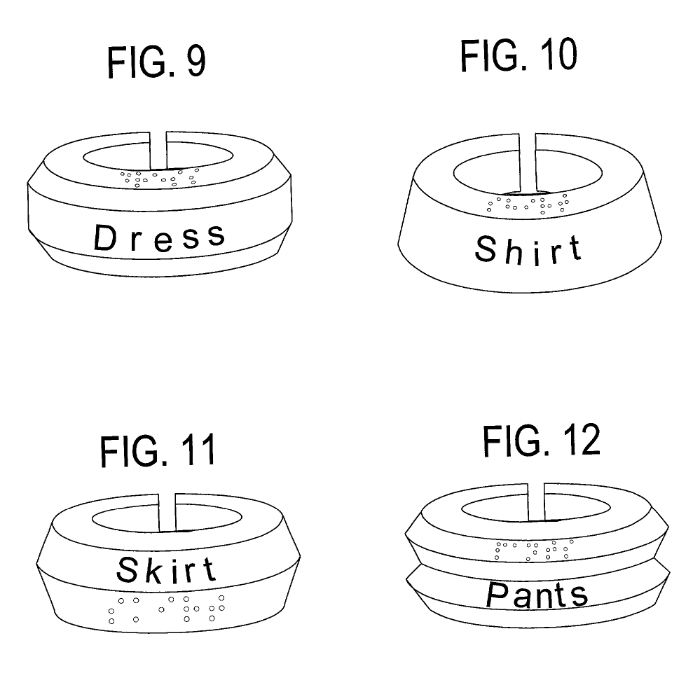

FIGS. 9-12 are diagrams of garment organizers for organizing individual hang-up garments by identifying a hanger holding a particular garment having a particular garment attribute in accordance with another exemplary embodiment of the present invention. With respect to the present exemplary embodiments, single garments are identified rather than groups of garment, so here the garment organizer are associate with a particular garment and affixed to that garment's hanger. Each of garment organizers 900-1200 are similar in that each has hole 902-1202 for receiving a hanger hook and slit 904-1204 for placement on the hanger, although in many cases closet garment organizers 900-1200 may merely be slid over the hanger hook, thus dispensing with the need for slit 904-1204. In general it is expected that the garment organizers are composed of a resilient and flexible substrate, such a polymer plastic. However, notice also that each of closet organizers 900-1200 differ from one another by four characteristics or attributes: three-dimensional shape; two-dimensional shape; text indicia; and Braille indicia. Here, representative three-dimensional shape correlates to a particular garment attribute. With respect to the specific garment organizers 900-1200, garment organizer shape attribute is the horizontal contour of the individual garment organizer. Vertical shape attributes could also be added to increase the quantity of possible garment attributes identified by the garment organizer, for example horizontal contours might correlate to garment color attributes while vertical shape striations might correlate to garment types. Of course this would be a fairly sophisticated system and not easily comprehended by a user.

Notice also that the three-dimensional shape attribute projects as a two-dimensional shape that might also be used to distinguish individual garment attributes. Thus, a user that need not comprehend either visual or Braille to identify a garment attribute the arbitrary two- or three-dimensional shape of the garment organizer. Here to messaging indicia is used, visual and Braille text for persons who can comprehend messaging indicia. As discussed above, and in accordance with one exemplary embodiment of the present invention, each of the three characteristics or attributes may correlate to a single garment attribute or may instead correlate to three different garment attributes. In the depicted figures, each of the three characteristics or attributes correlate to garment type. Thus, a challenged person might expeditiously locate a garment having a particular attribute by merely observing the garment organizers or by sliding a hand across the garment organizers while secured on the respective hangers. Similarly, a challenged person might expeditiously locate the portion of a closet containing a particular type of garment by viewing or touching individual closet organizers, because the search area is reduced from the entire closet to only one portion of the closet. In the presently depicted figures, garment type attributes are represented as “dresses,” “pants,” “skirts” and “shirts,” however this embodiment is merely exemplary. One of ordinary skill in the art would readily realize the other garment type attributes might be represented by the present closet organizers such as suits, coats, tee shirts, blouses, etc. Moreover, the depicted figures represent garment type attributes using three particular characteristics or attributes that correlate to a garment attribute. One of ordinary skill in the art would also readily realize the other closet organizer attributes might be used in place of or in conjunction with the three illustrated in the figures, for example raised text, other two-dimensional shape attributes, three-dimensional shape attribute, symbolic shapes, etc.

The present invention as depicted in FIGS. 9-12 is extremely useful in assisted living situations where the facility provides a laundry service for the challenged residents. In that case an individual garment organizer may be placed on each hanger after laundering. Housekeeping staff can then organize garments in a closet by garment attribute. Furthermore, the garment organizers depicted in FIGS. 9-12 may be used readily with any of the closet organizers depicted in FIGS. 1-8, thus further reducing the amount of effort needed to organize a residents closet.

Finally, because garment organizers 900-1200 identify individual garments rather than groups of garment having a common garment attribute, garment organizers 900-1200 are useful for blind or color blind persons. There, in addition to or in place of the visual text identifying garment type attributes, other visual indicia identifies garment color attributes. For example the visual indicia might display the text “RED SKIRT” rather than merely “SKIRT.” The tactile indicia 908-1208 also identifies the skirt as a red skirt. Additionally, the garment organizers may be cast is colors representative of a garment color attribute. In accordance with still another exemplary embodiment, iron-on decals may be used in conjunction with garment organizers 900-1200 for assisting colorblind persons identify and coordinate garments. An iron-on decal is iron onto a portion of a garment that is not visible when worn which identifies a garment's color attribute (this step must be performed by a person with normal color vision). Then, when the garment is laundered its color can determined by the identification label and hung on a hanger with a garment organizer which also identifies the garment's color. Thus, a color blind person can easily distinguish garment by color. However, since most colorblind persons have never experienced color, merely identifying a garment's color attribute is often not very helpful. Therefore, in accordance with still another exemplary embodiment of the present invention, a mountable color coordination chart is provided for the user to make color selections from. Thus, a colorblind person can easily correlate and contrast garments to be worn together by color.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

What is claimed is:

1. A organizer system for organizing wearing apparel in a storage area by implementing a plurality of organizers for demarcating a plurality of portions of the storage area, comprising:
a first organizer position physically proximate to at least one of first plurality of garments, each of the first plurality of garments having a common first garment attribute, said first organizer having a first physical attribute correlating to the first garment attribute, said first physical attribute of first organizer having a first physical attribute value and said first garment attribute having a first garment attribute value, said first physical attribute value correlates to said first garment attribute value; and
a second organizer position physically proximate to at least one a second plurality of garments, each of the second plurality of garments having the common first garment attribute, said second organizer having the first physical attribute correlating to the first garment attribute, said first physical attribute of second organizer having a second physical attribute value and said first garment attribute having a second garment attribute value, said second physical attribute value correlates to said second garment attribute value.

2. The system of claim 1, wherein the first and second organizers having a second physical attribute correlating to the first garment attribute, said second physical attribute of the first and second organizer having respective first and second physical attribute values, said first and second physical attribute value correlates to respective said first and second garment attribute values.

3. The system of claim 2, wherein the first, second and third organizers further comprise a hole for receiving a close rod and the second and third organizers are positioned physically proximate to the respective first and second plurality of garments having the common first garment attribute.

4. The system of claim 2, wherein the first, second and third organizers further comprise a hole for receiving a garment hanger hook.

5. The system of claim 2, wherein the first physical attribute is one of color, visual text, Braille text, raised text, two-dimensional shape attribute, three-dimensional shape attribute, symbolic shape and surface texture.

6. The method of claim 2, wherein the second physical attribute is another of color, visual text, Braille text, raised text, two-dimensional shape attribute, three-dimensional shape attribute, symbolic shape and surface texture.

7. The method of claim 2, wherein the first physical attribute does not correlate to garment size.

8. The method of claim 2, wherein the second physical garment attribute does not correlate to garment size.

9. The method of claim 2, wherein at least one of the first and second physical attributes is selected based on a challenged person's ability to comprehend the correlation between the physical attribute and the respective garment attribute.

10. The method of claim 2, wherein at least one of the first and second physical attributes is representative of the respective garment attribute.

11. A method organizing wearing apparel in a storage area by implementing a plurality of organizers for demarcating a plurality of portions of the storage area, comprising:
positioning a first organizer physically proximate to at least one of first plurality of garments, each of the first plurality of garments having a common first garment attribute, said first organizer having a first physical attribute correlating to the first garment attribute, said first physical attribute of first organizer having a first physical attribute value and said first garment attribute having a first garment attribute value, said first physical attribute value correlates to said first garment attribute value; and
positioning a second organizer physically proximate to at least one a second plurality of garments, each of the second plurality of garments having the common first garment attribute, said second organizer having the first physical attribute correlating to the first garment attribute, said first physical attribute of second organizer having a second physical attribute value and said first garment attribute having a second garment attribute value, said second physical attribute value correlates to said second garment attribute value.

12. The method of claim 11, wherein the first and second organizers having a second physical attribute correlating to the first garment attribute, said second physical attribute of the first and second organizer having respective first and second physical attribute values, said first and second physical attribute value correlates to respective said first and second garment attribute values.

13. The method of claim 12, wherein the first, second and third organizers further comprise a hole for receiving a close rod and the second and third organizers are positioned physically proximate to the respective first and second plurality of garments having the common first garment attribute.

14. The method of claim 12, wherein the first, second and third organizers further comprise a hole for receiving a garment hanger hook.

15. The method of claim 12, wherein the first physical attribute is one of color, visual text, Braille text, raised text, two-dimensional shape attribute, three-dimensional shape attribute, symbolic shape and surface texture.

16. The method of claim 12, wherein the second physical attribute is another of color, visual text, Braille text, raised text, two-dimensional shape attribute, three-dimensional shape attribute, symbolic shape and surface texture.

17. The method of claim 12, wherein the first physical attribute does not correlate to garment size.

18. The method of claim 12, wherein the second physical garment attribute does not correlate to garment size.

19. The method of claim 12, wherein at least one of the first and second physical attributes is selected based on a challenged person's ability to comprehend the correlation between the physical attribute and the respective garment attribute.

20. The method of claim 12, wherein at least one of the first and second physical attributes is representative of the respective garment attribute.
